(19) United States
(12) Patent Application Publication
(10) Pub. No.: US 2009/0196756 A1
(43) Pub. Date: Aug. 6, 2009

(54) Wind turbine blades and method for forming same

(75) Inventor: Nicholas Keane Althoff, Ware Shoals, SC (US)

Correspondence Address: PATRICK W. RASCHE (22402);ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 12/069,034

(22) Filed: Feb. 5, 2008

(51) Int. Cl. F01D 5/14; B23P 15/04

(52) U.S. Cl. 416/226; 29/889.71

(57) ABSTRACT

A method of forming a wind turbine blade includes forming a root portion, a tip portion, and an airfoil portion extending radially outward from the root portion to the tip portion. The method also includes forming a spar cap extending radially outward from the root portion through at least a portion of the airfoil portion. At least a portion of the spar cap is oriented substantially longitudinally and extends generally linearly from a first end of the spar cap to a second end of the spar cap. The method also includes forming at least one spar cap extension that extends from the spar cap, wherein at least a portion of the spar cap extension is oriented nonlinearly relative to the spar cap.

### BACKGROUND OF THE INVENTION

This invention relates generally to rotary machines and more particularly, to wind turbine blades and method for forming same.

Generally, a wind turbine includes a rotor having multiple blades. The rotor is mounted on a housing, or nacelle, that is positioned on top of a truss or tubular tower. Utility grade wind turbines (i.e., wind turbines designed to provide electrical power to a utility grid) can have large rotors, e.g., 30 meters (m) (98 feet (ft)) or more in diameter. Blades, attached to rotatable hubs on these rotors via a blade root portion, transform mechanical wind energy via an airfoil portion into a mechanical rotational torque that drives one or more generators. The generators convert the rotational mechanical energy to electrical energy, which is fed into a utility grid.

Some known blades are at least partially fabricated of a laminated (that is, layered) fiber/resin composite material, thereby forming a plurality of laminate plies, or laminated layers. In general, reinforcing fibers are deposited into a resin within a range of predetermined orientations within each laminated layer. The fiber orientations are often determined by a range of expected stress, or load factors that a blade may experience during an expected blade lifetime. Moreover, some known blades are formed from a plurality of blade components, wherein at least some of such components are formed with laminated layers as described above. Such blade components include a central spar, or spar cap that longitudinally extends along substantially an entire span of the blade, including the root and airfoil portions. Additional blade components may include laminated fiber/resin leading edge and trailing edge stiffening members. The blade components are subsequently assembled to form the wind turbine blade.

The spar cap and the stiffening members are load-bearing members that form load paths. Aerodynamic loads that are carried by these load-bearing members are typically transferred to the root portion. Because the members have finite widths with finite variances, these load paths are unevenly distributed and are likely asymmetric about any given plane in the root portion. An accompanying asymmetric load dispersion within the root portion facilitates some regions of the root portion experiencing loading above that of other regions, thereby facilitating uneven wear within the blade that may induce distortion of the root portion.

### BRIEF DESCRIPTION OF THE INVENTION

In one aspect, a method of forming a wind turbine blade is provided. The method includes forming a root portion, a tip portion, and an airfoil portion extending radially outward from the root portion to the tip portion. The method also includes forming a spar cap extending radially outward from the root portion through at least a portion of the airfoil portion. At least a portion of the spar cap is oriented substantially longitudinally and extends generally linearly from a first end of the spar cap to a second end of the spar cap. The method also includes forming at least one spar cap extension that extends from the spar cap, wherein at least a portion of the spar cap extension is oriented nonlinearly relative to the spar cap.

In another aspect, a wind turbine blade is provided. The wind turbine blade includes a root portion, a tip portion, and an airfoil portion extending radially outward from the root portion to the tip portion. The blade also includes a spar cap extending radially outward from the root portion through at least a portion of the airfoil portion. At least a portion of the spar cap is oriented substantially longitudinally and extends generally linearly from a first end of the spar cap to a second end of the spar cap. The blade further includes at least one spar cap extension that extends from the spar cap. At least a portion of the spar cap extension is oriented nonlinearly relative to the spar cap.

In a further aspect, a wind turbine system is provided. The system includes a rotatable member rotatably coupled to a load and at least one wind turbine blade coupled to the rotatable member. The wind turbine blade includes a root portion, a tip portion, and an airfoil portion extending radially outward from the root portion to the tip portion. The blade also includes a spar cap extending radially outward from the root portion through at least a portion of the airfoil portion. At least a portion of the spar cap is oriented substantially longitudinally and extends generally linearly from a first end of the spar cap to a second end of the spar cap. The blade further includes at least one spar cap extension that extends from the spar cap. At least a portion of the spar cap extension is oriented nonlinearly relative to the spar cap.

### BRIEF DESCRIPTION OF THE DRAWINGS

FIG. 1 is an orthographic view of an exemplary wind turbine system;

FIG. 2 is an overhead view of a portion of an exemplary wind turbine blade that may be used with the wind turbine system in FIG. 1;

FIG. 3 is an orthographic view of a portion of the exemplary wind turbine blade shown in FIG. 2;

FIG. 4 is an overhead view of a portion of an alternative wind turbine blade that may be used with the wind turbine system in FIG. 1;

FIG. 5 is an orthographic view of a portion of the alternative wind turbine blade shown in FIG. 4;

FIG. 6 is an overhead view of a portion of another alternative wind turbine blade that may be used with the wind turbine system in FIG. 1; and

FIG. 7 is an overhead view of a portion of another alternative wind turbine blade that may be used with the wind turbine system in FIG. 1.

### DETAILED DESCRIPTION OF THE INVENTION

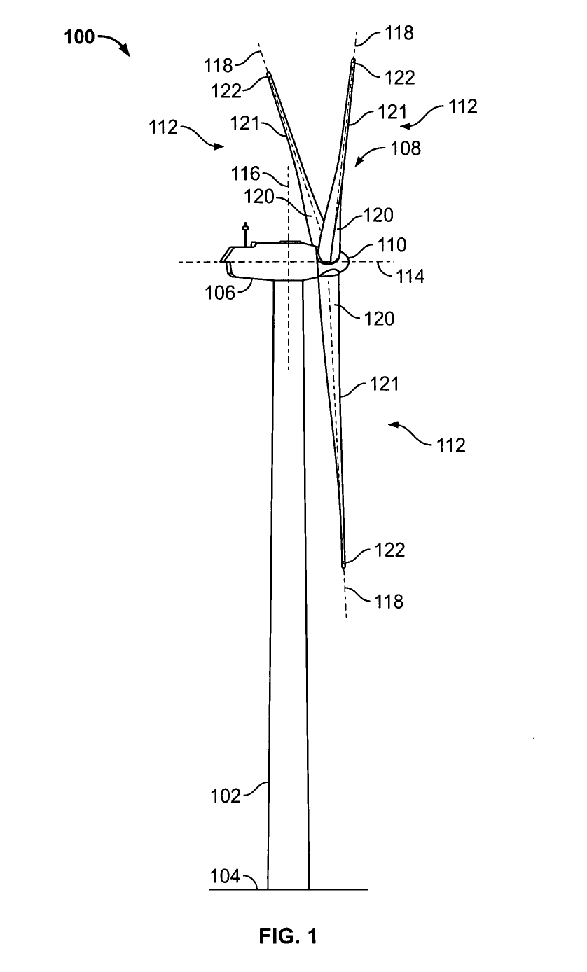

FIG. 1 is an orthographic view of an exemplary wind turbine system 100. In the exemplary embodiment, system 100 is a horizontal axis wind turbine. Alternatively, system 100 may be a vertical axis wind turbine. Wind turbine 100 has a tower 102 extending from a supporting surface 104, a nacelle 106 mounted on tower 102, and a rotor 108 coupled to nacelle 106. Rotor 108 has a rotatable hub 110 and a plurality of wind turbine rotor blades 112 coupled to hub 110. In the exemplary embodiment, rotor 108 has three wind turbine blades 112. In an alternative embodiment, rotor 108 may have more or less than three blades 112. Rotor 108, hub 110, and blades 112 are oriented and configured to rotate about a rotation axis 114. In the exemplary embodiment, tower 102 is fabricated from tubular steel and has a cavity (not shown) extending between supporting surface 104 and nacelle 106. In an alternative embodiment, tower 102 is a lattice tower.

Various components of wind turbine 100, in the exemplary embodiment, are housed in nacelle 106 atop tower 102 of wind turbine 100. For example, rotor 108 is coupled to an electric generator (not shown in FIG. 1) that is positioned within nacelle 106. Rotation of rotor 108 about axis 114 facilitates production of electric power generation by the generator. Also positioned in nacelle 106 is a yaw adjustment mechanism (not shown) that may be used to rotate nacelle 106 and rotor 108 on a yaw axis 116 to control the perspective of blades 112 with respect to the direction of the wind. The height of tower 102 is selected based upon factors and conditions known in the art.

In the exemplary embodiment, blades 112 may have any length that facilitates operation of wind turbine 100 as described herein. Blades 112 are positioned about rotor hub 110 to facilitate rotating rotor 108 to transfer kinetic energy from wind into usable mechanical energy, and subsequently, electrical energy. As wind strikes blades 112, rotor 108 is rotated about rotation axis 114. As blades are rotated and subjected to centrifugal forces, blades are subjected to various bending moments and other operational stresses. As such, blades may deflect and/or rotate from a neutral, or non-deflected, position to a deflected position and an associated stress may be induced in blades.

In the exemplary embodiment, blades are rotated about a pitch axis 118. Specifically, a pitch angle (not shown) of blades, i.e., the angle that determines blades perspective with respect to the direction of wind, may be changed by a pitch adjustment mechanism (not shown) to facilitate increasing or decreasing a speed of rotor 108 by adjusting the surface area of blades exposed to wind force vectors. In the exemplary embodiment, the pitches of blades are controlled individually. Alternatively, the pitch of blades is controlled as a group.

Each of blades 112 includes a blade root portion 120 that facilitates mating each of blades 112 to hub 110. Moreover, each of blades 112 also includes a blade tip portion 122 positioned at a longitudinally outermost portion of each of blades 112. Also, each of blades 112 includes an airfoil portion 121 that extends between portions 120 and 122, wherein portion 121 receives a majority of air flow that transits across blades 112.

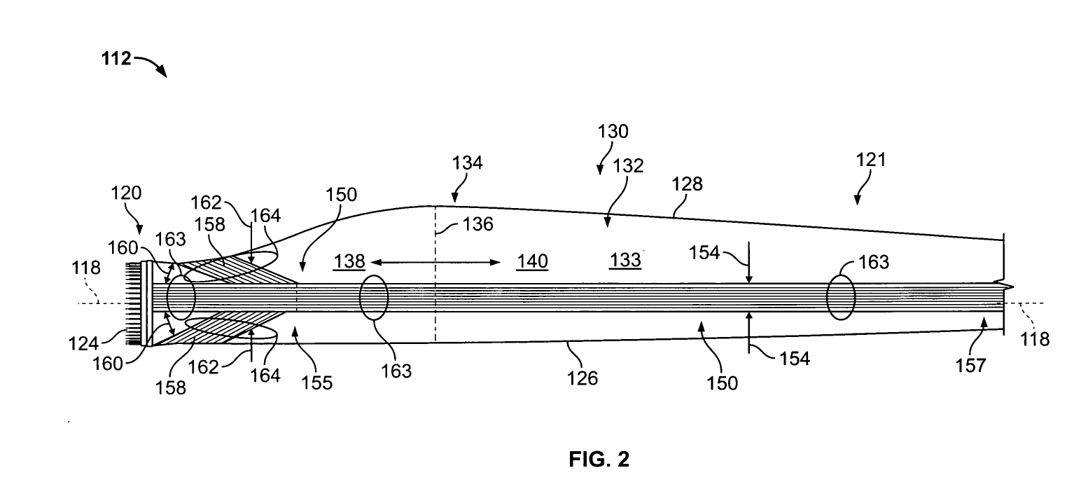

FIG. 2 is an overhead view of a portion of one exemplary wind turbine blade 112 that may be used with wind turbine system 100 (shown in FIG. 1). Pitch axis 118, blade root portion 120 and airfoil portion 121 are illustrated for perspective. A hub attachment apparatus 124 is coupled to root portion 120, wherein apparatus 124 facilitates mating blade 112 to hub 110 (shown in FIG. 1). Blade 112 includes a leading edge 126 and a trailing edge 128. Blade 112 also includes a fiber-reinforced resin body, or outer skin 130, that extends substantially over all of blade 112. Skin 130 includes an outer surface 132 and an inner surface and a thickness (both not shown in FIG. 2). Outer surface 132 includes a suction side surface 133 and a pressure side surface (not shown) on the opposite side of blade 112. Typically, the thickness of outer skin 130 is a function of a predetermined loading within each of a plurality of specific portions of blade 112, wherein such loading is determined as is known in the art.

Blade 112 also includes a first, or maximum chordal dimension portion 134 that extends substantially orthogonally between leading edge 126 and trailing edge 128. Portion 134 at least partially defines a first, or maximum chordal dimension 136. Portion 134 also at least partially defines a longitudinally inner portion 138 of blade 112 that extends from maximum chordal dimension 136 to root portion 120. Moreover, portion 134 at least partially defines a longitudinally outer portion 140 on blade 112 that extends from maximum chordal dimension 136 to tip portion 122 (shown in FIG. 1).

Blade 112 further includes a first spar cap 150 extending through at least a portion of each of portions 120 and 121, as well as portions 138 and 140 on suction side surface 133. Moreover, blade 112 includes a second spar cap (not shown) on the pressure side surface that is substantially similar to spar cap 150. In the exemplary embodiment, spar cap 150 is positioned in the vicinity of a thickest portion (not shown) of skin 130. Alternatively, spar cap 150 is positioned anywhere on blade 112 that facilitates operation of blade 112 as described herein. Spar cap 150 defines a second chordal dimension 154 that is less than first, or maximum chordal dimension 136.

Moreover, spar cap 150 includes a first end 155 that is positioned in portion 138. Specifically, in the exemplary embodiment, first end 155 is positioned within portion 120 substantially close to apparatus 124. Furthermore, spar cap 150 includes a second end 157 that is positioned in portion 140. Specifically, in the exemplary embodiment, second end 157 is positioned within portion 122. Spar cap 150 is oriented substantially longitudinally and extends generally linearly from first end 155 to second end 157. Alternatively, first end 155 and second end 157 are positioned anywhere on blade 112 with any orientation that facilitates operation of blade 112 as described herein.

Blade 112 also includes at least one circumferential spar cap extension 158, wherein, each of extensions 158 extend nonlinearly relative to spar cap 150. Specifically, each of extensions 158 extend at least partially circumferentially outward from a portion of spar cap 150 at an angle 160 with spar cap 150. In the exemplary embodiment, blade 112 includes two extensions 158. Also, in the exemplary embodiment, angle 160 is between 0° and 40°. Alternatively, there are any number of extensions 158 at any angle 160 that facilitate operation of blade 112 as described herein.

Both extensions 158, in conjunction with spar cap 150, define a third chordal dimension 162, wherein third chordal dimension 162 is greater than second chordal dimension 154 and is less than first, or maximum chordal dimension 136. As spar cap extensions 158 extend circumferentially outward from spar cap 150, third chordal dimension 162 increases from a value approximately equal to second chordal dimension 154 to a predetermined maximum value (not shown) that is at least partially based on predetermined load transfer characteristics of blade 112.

In the exemplary embodiment, skin 130, spar cap 150 and extensions 158 are at least partially formed of a fiber-resin matrix (not shown) that includes a plurality of plies (not shown) using known methods. Specifically, in the exemplary embodiment, the fiber resin matrix is formed via known infusion methods wherein a plurality of layers of a reinforcing material (not shown) is positioned within a mold (not shown) and the reinforcing material is saturated with a resin (not shown) and heat-cured, wherein each of the layers form each of the plies (not shown) within the fiber-resin matrix. Further, in the exemplary embodiment, the reinforcing material is a plurality of layers of continuous fiberglass filaments (not shown) and the resin is a thermosetting epoxy resin (not shown). Alternatively, any materials that facilitate forming blades 112 as described herein are used.

Also, alternatively, known hand lay-up fabrication methods to form a fiber-resin matrix are used. Specifically, a layer of predetermined reinforcing material (not shown) is placed into a mold structure (not shown) and a predetermined resin (not shown) is subsequently added into the mold to saturate the reinforcing material, thereby at least partially forming a first layer (not shown) of the fiber-resin matrix. Additional layers (not shown) may be added in a manner similar to that described above. Subsequently, the saturated layers are cured within the mold, wherein each of the layers form each of the plies (not shown) within the fiber-resin matrix. Further, as in the exemplary embodiment, in this alternative embodiment, the reinforcing material is a plurality of layers of continuous fiberglass filaments (not shown) and the resin is a thermosetting epoxy resin (not shown). Alternatively, any materials that facilitate forming blades 112 as described herein are used.

In the exemplary and alternative embodiments, the fiber resin matrix for spar cap 150 are formed by assembly methods that include using a plurality of first fiber filaments 163, wherein fiber filaments 163 are substantially continuous and have predetermined orientations within spar cap 150 based on desired load-carrying characteristics of blade 112. In the exemplary embodiment, such orientation is substantially unidirectional. Alternatively, fiber filaments 163 have any orientation that facilitates operation of blade 112 as described herein. Also, alternatively, fiber filaments 163 are formed into strands (not shown) using known assembly methods. Further, alternatively, the strands are formed into rovings (not shown) using known assembly methods. Moreover, alternatively, a combination of the three filament assembly methods are used together in a predetermined combination that is at least partially based on predetermined load transfers characteristics of blade 112.

Further, in the exemplary embodiment, spar cap extensions 158 are formed from a second plurality of fiber filaments 164 via at least one of the assembly methods described above, wherein filaments 164 (and/or strands and/or rovings, neither shown) are substantially continuous and unidirectional, wherein these filaments 164 intersect, or crossover with filaments 163 in spar cap 150 at angle 160. Orientations and configurations of filaments 164 with respect to filaments 163 are at least partially based on predetermined load transfer characteristics of blade 112.

An exemplary method of forming wind turbine blade 112 includes forming root portion 120, tip portion 122, and airfoil portion 121 extending radially outward from root portion 120 to tip portion 122. The method also includes forming spar cap 150 extending radially outward from root portion 120 through at least a portion of airfoil portion 121. At least a portion of spar cap 150 is oriented substantially longitudinal and extends generally linearly from first end 155 of spar cap 150 to second end 157 of spar cap 150. The method also includes forming at least one spar cap extension 158 extending from spar cap 150, wherein at least a portion of spar cap extension 158 is oriented nonlinearly relative to spar cap 150.

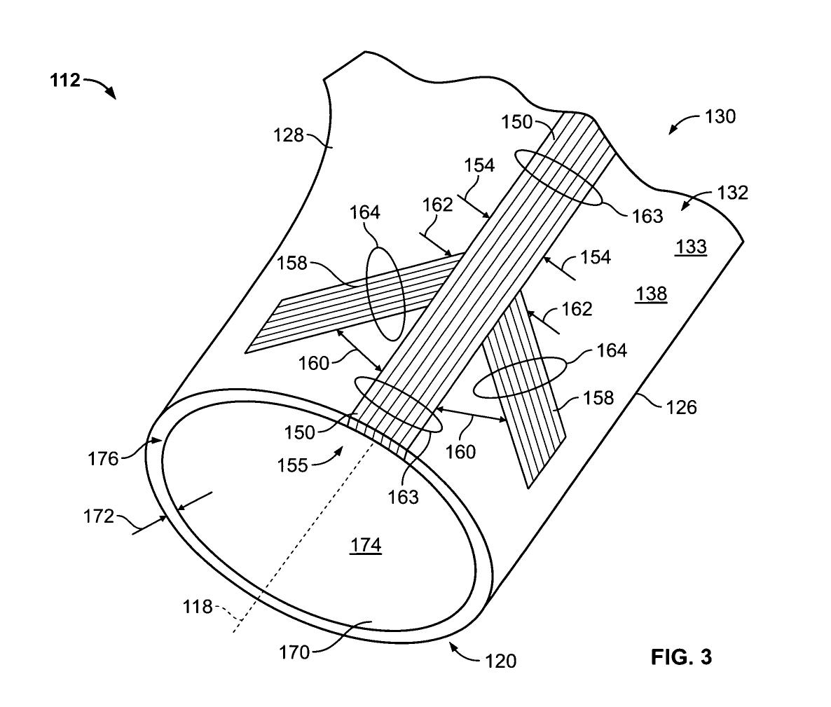

FIG. 3 is an orthographic view of a portion of wind turbine blade 112. Blade 112 also includes an inner surface 170 and a thickness 172 defined between inner surface 170 and outer surface 132. In the exemplary embodiment, thickness 172 has any value that facilitates operation of blade 112. Moreover, inner surface 170 at least partially defines a blade cavity 174. In the exemplary embodiment, cavity 174 includes a plurality of blade structural support members (not shown). Alternatively, cavity 174 includes features such as, but not limited to, heating channels, monitoring devices, and access passages (neither shown).

In the exemplary embodiment, an end face surface 176 is defined between inner surface 170 and outer surface 132, wherein surface 176 facilitates receipt of a portion of hub attachment apparatus 124 (shown in FIG. 2). Also, in the exemplary embodiment, spar cap extensions 158 extend longitudinally along surface 132 to a region short of surface 176. Alternatively, extensions 158 extend to surface 176, wherein at least a portion of filaments 164 in a longitudinally outmost portion of extensions 158 flare outward (not shown in FIG. 3).

Spar cap 150 and extensions 158 facilitate load transfer and load management within blade 112 by facilitating even distribution of load paths such that the associated loads are symmetrically loaded and dispersed at root portion 120 or, alternatively, such loads are distributed with a desired load configuration. Such load distribution facilitates mitigating fatigue and distortion of blade 112 at root portion 120, thereby facilitating mitigation of operational repair costs and capital replacement costs.

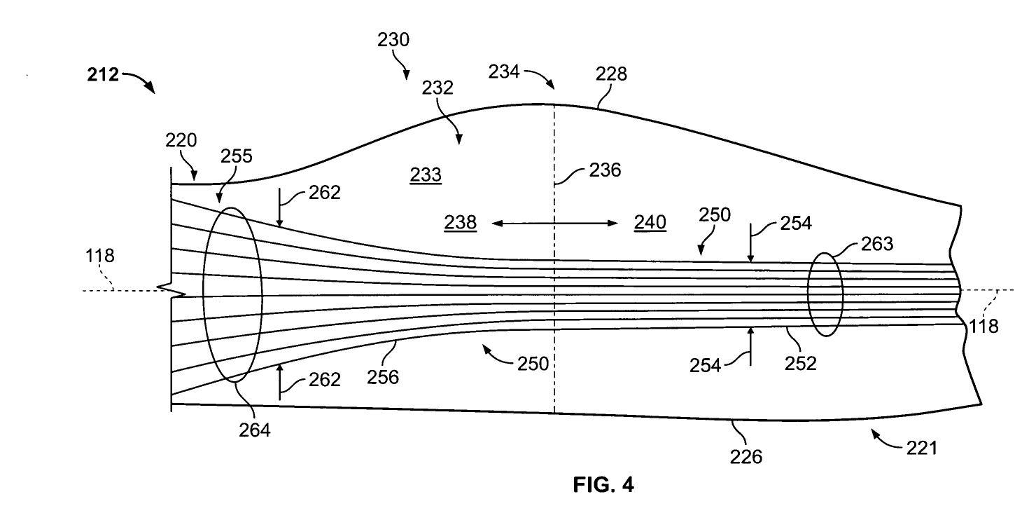

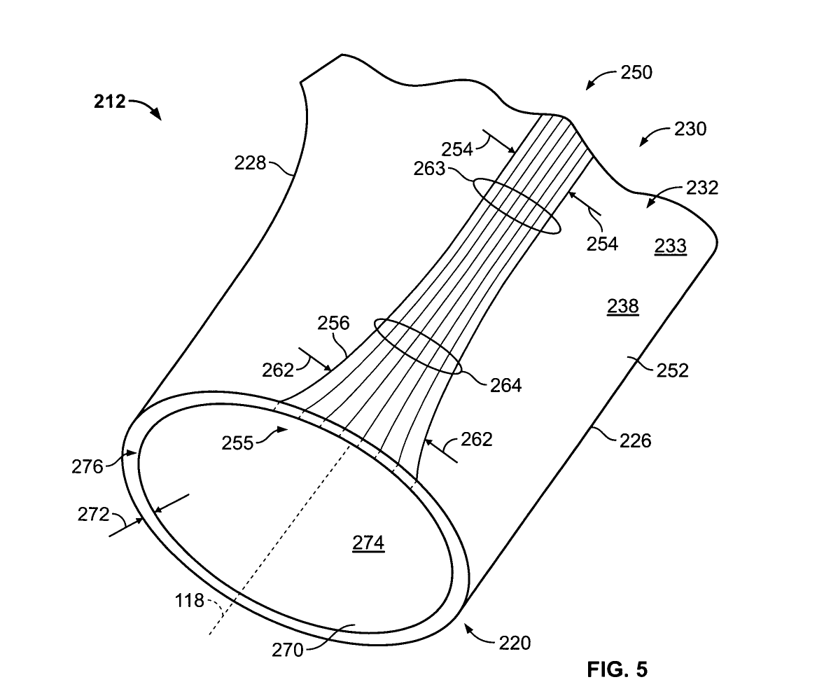

FIG. 4 is an overhead view of a portion of an alternative wind turbine blade 212 that may be used with wind turbine system 100 (shown in FIG. 1). FIG. 5 is an orthographic view of a portion of alternative wind turbine blade 212. Pitch axis 118, an alternative blade root portion 220 and an alternative airfoil portion 221 are illustrated for perspective. A hub attachment apparatus (not shown) is coupled to root portion 220, wherein the apparatus facilitates mating blade 212 to hub 110 (shown in FIG. 1). Blade 212 includes a leading edge 226 and a trailing edge 228. Blade 212 also includes a fiber-reinforced resin body, or outer skin 230, that extends substantially over all of blade 212. Skin 230 includes an outer surface 232. Outer surface 232 includes a suction side surface 233 and a pressure side surface (not shown) on the opposite side of blade 212. Typically, the thickness of outer skin 230 is a function of a predetermined loading within each of a plurality of specific portions of blade 212, wherein such loading is determined as is known in the art.

Blade 212 also includes a first, or maximum chordal dimension portion 234 that extends substantially orthogonally between leading edge 226 and trailing edge 228. Portion 234 at least partially defines a first, or maximum chordal dimension 236. Portion 234 also at least partially defines a longitudinally inner portion 238 of blade 212 that extends from maximum chordal dimension 236 to root portion 220. Moreover, portion 234 at least partially defines a longitudinally outer portion 240 on blade 212 that extends from maximum chordal dimension 236 to tip portion 122 (shown in FIG. 1).

Blade 212 further includes a first spar cap 250 extending through at least a portion of each of portions 220 and 221, as well as portions 238 and 240 on suction surface side 233. Moreover, blade 212 includes a second spar cap (not shown) on the pressure side surface that is substantially similar to spar cap 250. Spar cap 250 includes a first, or central spar cap section 252 that extends longitudinally outward through substantially all of longitudinally outer portion 240 from at least maximum chordal dimension 236 to tip portion 122. Spar cap section 252 defines a second chordal dimension 254 that is less than first, or maximum chordal dimension 236.

Spar cap 250 also includes a first end 255 that is positioned in portion 238. Specifically, in this alternative embodiment, first end 255 is positioned within portion 220. Furthermore, spar cap 250 includes a second end (not shown) that is positioned in portion 240. At least a portion of spar cap 250 is oriented substantially longitudinally and extends generally linearly from first end 255 to the second end. Alternatively, first end 255 and the second end are positioned anywhere on blade 212 with any orientation that facilitates operation of blade 212 as described herein.

Spar cap 250 also includes a second, or root end extended section 256 that extends at least partially longitudinally inward from chord 236. Section 256 is flared outward from section 252 and defines a third chordal dimension 262, wherein third chordal dimension 262 is greater than second chordal dimension 254 and is less than first, or maximum chordal dimension 236. As second spar cap section 256 extends longitudinally inward from portion 234 toward blade root portion 220, third chordal dimension 262 increases from a value approximately equal to second chordal dimension 254 to a predetermined maximum value (not shown) that is at least partially based on predetermined load transfer characteristics of blade 212.

In the alternative embodiment, skin 230 and spar cap 250 are at least partially formed of a fiber-resin matrix (not shown) that includes a plurality of plies (not shown) using known methods. Specifically, in the alternative embodiment, the fiber resin matrix is formed via known infusion methods wherein a plurality of layers of a reinforcing material (not shown) is positioned within a mold (not shown) and the reinforcing material is saturated with a resin (not shown) and heat-cured, wherein each of the layers form each of the plies (not shown) within the fiber-resin matrix. Further, in the alternative embodiment, the reinforcing material is a plurality of layers of continuous fiberglass filaments (not shown) and the resin is a thermosetting epoxy resin (not shown). Alternatively, any materials that facilitate forming blade 212 as described herein are used.

Also, alternatively, known hand lay-up fabrication methods to form a fiber-resin matrix are used. Specifically, a layer of predetermined reinforcing material (not shown) is placed into a mold structure (not shown) and a predetermined resin (not shown) is subsequently added into the mold to saturate the reinforcing material, thereby at least partially forming a first layer (not shown) of the fiber-resin matrix. Additional layers (not shown) may be added in a manner similar to that described above. Subsequently, the saturated layers are cured within the mold, wherein each of the layers form each of the plies (not shown) within the fiber-resin matrix. Further, as in the exemplary embodiment, in this alternative embodiment, the reinforcing material is a plurality of layers of continuous fiberglass filaments (not shown) and the resin is a thermosetting epoxy resin (not shown). Alternatively, any materials that facilitate forming blades 212 as described herein are used.

In the alternative embodiment, the fiber resin matrix for first (central) spar cap section 252 is formed by assembly methods that include using a plurality of first fiber filaments 263, wherein fiber filaments 263 are substantially continuous and have predetermined orientations within section 252 based on desired load-carrying characteristics of blade 212. In the exemplary embodiment, such orientation is substantially unidirectional. Alternatively, fiber filaments 263 have any orientation that facilitates operation of blade 212 as described herein. Also, alternatively, fiber filaments 263 are formed into strands (not shown) using known assembly methods. Further, alternatively, the strands are formed into rovings (not shown) using known assembly methods. Moreover, alternatively, a combination of the three filament assembly methods are used together in a predetermined combination that is at least partially based on predetermined load transfers characteristics of blade 212.

Further, in the alternative embodiment, first fiber filaments 263 extend into extended spar cap section 256 from central spar cap section 252 to form a second plurality fiber filaments 264, wherein filaments 264 are substantially continuous. In this alternative embodiment, at least some of fiber filaments 263 are circumferentially separated, or fanned out, such that a first density of fiber filaments 263 in section 252 is greater than a second density of fiber filaments 264 within section 256, while a remainder of fiber elements 263 retain the original orientation. Such fanning out of at least a portion of fiber filaments 263 facilitates a flaring of section 256.

Also, in another alternative embodiment, spar cap section 256 is formed from a plurality of separate fiber filaments (not shown) that are integrated with first fiber filaments 263, wherein such separate filaments facilitate at least partially forming second continuous fiber filaments 264. Further, alternatively, such additional fiber filaments being integrated with extended filaments 263 within section 256 mitigates a decrease in fiber filament density as spar cap 250 transitions from section 252 to section 256, wherein a predetermined fiber filament density within section 256 is at least partially based on predetermined load transfer characteristics of blade 212. Moreover, a rate and magnitude of fiber filament fanning, and therefore a magnitude of flaring of section 256, are predetermined at least partially based on predetermined load transfer characteristics of blade 212.

Blade 212 also includes an inner surface 270 and a thickness 272 defined between inner surface 270 and outer surface 232. Typically, the thickness of outer skin 230 is a function of a predetermined loading within each of a plurality of specific portions of blade 212, wherein such loading is determined as is known in the art. In the exemplary embodiment, thickness 272 has any value that facilitates operation of blade 212. Moreover, inner surface 270 at least partially defines a blade cavity 274. In the exemplary embodiment, cavity 274 includes a plurality of blade structural support members (not shown). Alternatively, cavity 274 includes features such as, but not limited to, heating channels, monitoring devices, and access passages (neither shown). Also, in the alternative embodiment, an end face surface 276 is defined between inner surface 270 and outer surface 232, wherein surface 276 facilitates receipt of a portion of the hub attachment apparatus.

Spar cap 250 facilitates load transfer and load management within blade 212 by facilitating even distribution of load paths such that the associated loads are symmetrically loaded and dispersed at root portion 220 or, alternatively, such loads are distributed with a desired load configuration. Such load distribution facilitates mitigating fatigue and distortion of blade 212 at root portion 220, thereby facilitating mitigation of operational repair costs and capital replacement costs.

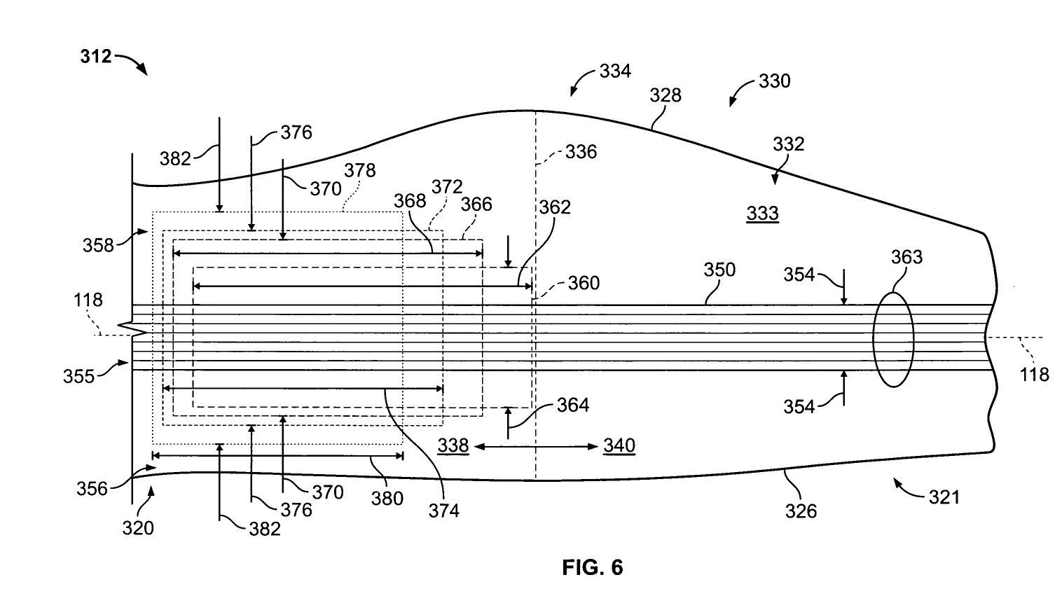

FIG. 6 is an overhead view of a portion of another alternative wind turbine blade 312 that may be used with wind turbine system 100 (shown in FIG. 1). Pitch axis 118, an alternative blade root portion 320 and an alternative airfoil portion 321 are illustrated for perspective. A hub attachment apparatus (not shown) is coupled to root portion 320, wherein the apparatus facilitates mating blade 312 to hub 110 (shown in FIG. 1). Blade 312 includes a leading edge 326 and a trailing edge 328. Blade 312 also includes a fiber-reinforced resin body, or outer skin 330, that extends substantially over all of blade 312. Skin 330 includes an outer surface 332. Outer surface 332 includes a suction side surface 333 and a pressure side surface (not shown) on the opposite side of blade 312. Typically, the thickness of outer skin 330 is a function of a predetermined loading within each of a plurality of specific portions of blade 312, wherein such loading is determined as is known in the art.

Blade 312 also includes a first, or maximum chordal dimension portion 334 that extends substantially orthogonally between leading edge 326 and trailing edge 328. Portion 334 at least partially defines a first, or maximum chordal dimension 336. Portion 334 also at least partially defines a longitudinally inner portion 338 of blade 312 that extends from maximum chordal dimension 336 to root portion 320. Moreover, portion 334 at least partially defines a longitudinally outer portion 340 on blade 312 that extends from maximum chordal dimension 336 to tip portion 122 (shown in FIG. 1).

Blade 312 further includes a first spar cap 350 extending through at least a portion of each of portions 320 and 321, as well as portions 338 and 340 on suction side surface 333. Moreover, blade 312 includes a second spar cap (not shown) on the pressure side surface that is substantially similar to spar cap 350. In the exemplary embodiment, spar cap 350 is positioned in the vicinity of a thickest portion (not shown) of skin 330. Alternatively, spar cap 350 is positioned anywhere on blade 312 that facilitates operation of blade 312 as described herein. Spar cap 350 defines a second chordal dimension 354 that is less than first, or maximum chordal dimension 336. Spar cap 350 also includes a first end 355 that is positioned in portion 338. Specifically, in this alternative embodiment, first end 355 is positioned within portion 320. Furthermore, spar cap 350 includes a second end (not shown) that is positioned in portion 340. Alternatively, first end 355 and the second end are positioned anywhere on blade 312 that facilitates operation of blade 312 as described herein. Spar cap 350 is oriented substantially longitudinally and extends generally linearly from first end 355 to the second end.

Blade 312 also includes a root end extended section 356 that extends at least partially longitudinally inward from chord 336. In this alternative embodiment, section 356 includes a plurality of overlapping plies 358, wherein at least a portion of plies 358 overlap spar cap 350 and at least a portion of each other. Specifically, in this alternative embodiment, there are four overlapping plies 358. More specifically, in this alternative embodiment, section 356 includes a first overlapping ply 360. Ply 360 extends longitudinally inward from approximately portion 334 to define a first longitudinal dimension 362 and overlaps at least a portion of spar cap 350. Ply 360 defines a third chordal dimension 364 that is greater than second chordal dimension 354 and less than first chordal dimension 336.

Also, specifically, in this alternative embodiment, section 356 includes a second overlapping ply 366. Ply 366 extends longitudinally inward from a longitudinally outer portion of ply 360 to define a second longitudinal dimension 368 and overlaps at least a portion of ply 360. Ply 366 defines a fourth chordal dimension 370 that is greater than third chordal dimension 364 and less than first chordal dimension 336.

Further, specifically, in this alternative embodiment, section 356 includes a third overlapping ply 372. Ply 372 extends longitudinally inward from a longitudinally outer portion of ply 366 to define a third longitudinal dimension 374 and overlaps at least a portion of ply 366. Ply 372 defines a fifth chordal dimension 376 that is greater than fourth chordal dimension 370 and less than first chordal dimension 336.

Moreover, specifically, in this alternative embodiment, section 356 includes a fourth overlapping ply 378. Ply 378 extends longitudinally inward from a longitudinally outer portion of ply 372 to define a fourth longitudinal dimension 380 and overlaps at least a portion of ply 372. Ply 378 defines a sixth chordal dimension 382 that is greater than fifth chordal dimension 376 and less than first chordal dimension 336.

In the alternative embodiment, skin 330, spar cap 350 and root end extended section 356 are at least partially formed of a fiber-resin matrix (not shown) that includes a plurality of plies (not shown) using known methods. Specifically, in this alternative embodiment, the fiber resin matrix is formed via known infusion methods wherein a plurality of layers of a reinforcing material (not shown) is positioned within a mold (not shown) and the reinforcing material is saturated with a resin (not shown) and heat-cured, wherein each of the layers form each of the plies (not shown) within the fiber-resin matrix. Further, in the alternative embodiment, the reinforcing material is a plurality of layers of continuous fiberglass filaments (not shown) and the resin is a thermosetting epoxy resin (not shown). Alternatively, any materials that facilitate forming blade 312 as described herein are used.

Also, alternatively, known hand lay-up fabrication methods to form a fiber-resin matrix are used. Specifically, a layer of predetermined reinforcing material (not shown) is placed into a mold structure (not shown) and a predetermined resin (not shown) is subsequently added into the mold to saturate the reinforcing material, thereby at least partially forming a first layer (not shown) of the fiber-resin matrix. Additional layers (not shown) may be added in a manner similar to that described above. Subsequently, the saturated layers are cured within the mold, wherein each of the layers form each of the plies (not shown) within the fiber-resin matrix. Further, in this alternative embodiment, the reinforcing material is a plurality of layers of continuous fiberglass filaments (not shown) and the resin is a thermosetting epoxy resin (not shown). Alternatively, any materials that facilitate forming blades 312 as described herein are used.

In the alternative embodiment, the fiber resin matrix for spar cap section 350 is formed by assembly methods that include using a plurality of first fiber filaments 363, wherein fiber filaments 363 are substantially continuous and have predetermined orientations within spar cap 350 based on desired load-carrying characteristics of blade 312. In the exemplary embodiment, such orientation is substantially unidirectional. Alternatively, fiber filaments 363 have any orientation that facilitates operation of blade 312 as described herein. Also, alternatively, fiber filaments 363 are formed into strands (not shown) using known assembly methods. Further, alternatively, the strands are formed into rovings (not shown) using known assembly methods. Moreover, alternatively, a combination of the three filament assembly methods are used together in a predetermined combination that is at least partially based on predetermined load transfers characteristics of blade 312.

Further, in this alternative embodiment, each of overlapping plies 358 is similarly formed with a predetermined number of fiber filaments (and/or strands and/or rovings, neither shown) with predetermined lengths and densities that are based on predetermined load-carrying characteristics of blade 312. Moreover, such orientation of each ply 358 to the other plies 358 and spar cap 350 facilitates simulating a flaring effect. Also, each of plies 358 has any longitudinal dimension with any overlapping configuration with any one of plies 358 and spar cap 350 that facilitates operation of blade 312 as described herein. Furthermore, a longitudinal innermost portion of each of plies 358 may be fanned and flared in a manner similar to that described above for section 256 of blade 212 (both shown in FIGS. 4 and 5).

Spar cap 350 and plies 358 facilitate load transfer and load management within blade 312 by facilitating even distribution of load paths such that the associated loads are symmetrically loaded and dispersed at root portion 320 or, alternatively, such loads are distributed with a desired load configuration. Such load distribution facilitates mitigating fatigue and distortion of blade 312 at root portion 320, thereby facilitating mitigation of operational repair costs and capital replacement costs.

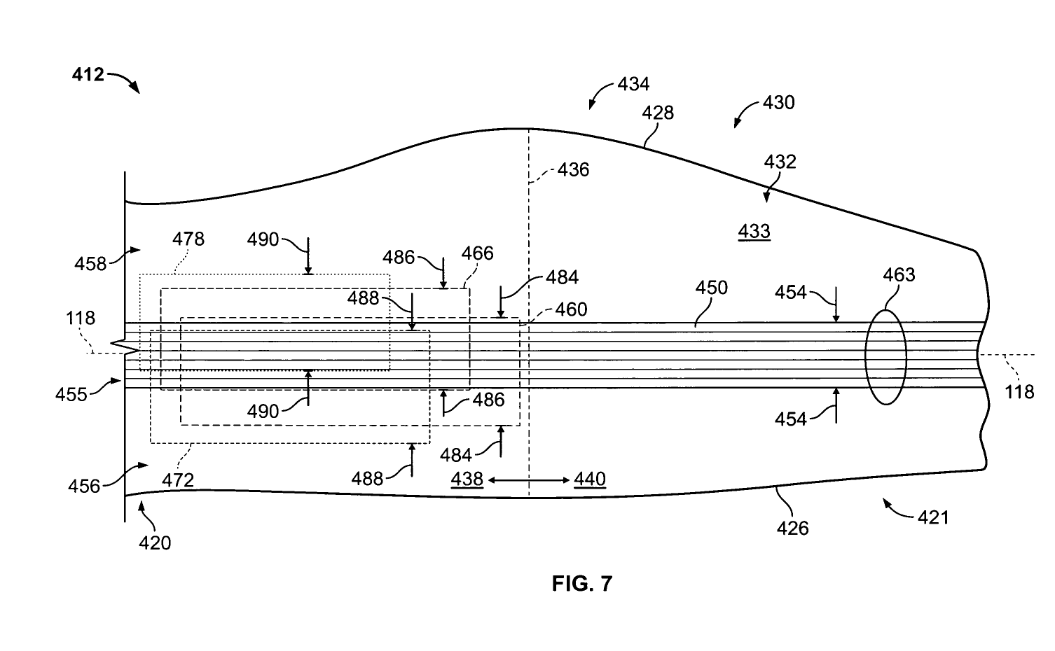

FIG. 7 is an overhead view of a portion of another alternative wind turbine blade 412 that may be used with wind turbine system 100 (shown in FIG. 1). Pitch axis 118, an alternative blade root portion 420 and an alternative airfoil portion 421 are illustrated for perspective. A hub attachment apparatus (not shown) is coupled to root portion 420, wherein the apparatus facilitates mating blade 412 to hub 110 (shown in FIG. 1). Blade 412 includes a leading edge 426 and a trailing edge 428. Blade 412 also includes a fiber-reinforced resin body, or outer skin 430, that extends substantially over all of blade 412. Skin 430 includes an outer surface 432. Outer surface 432 includes a suction side surface 433 and a pressure side surface (not shown) on the opposite side of blade 412. Typically, the thickness of outer skin 430 is a function of a predetermined loading within each of a plurality of specific portions of blade 412, wherein such loading is determined as is known in the art.

Blade 412 also includes a first, or maximum chordal dimension portion 434 that extends substantially orthogonally between leading edge 426 and trailing edge 428. Portion 434 at least partially defines a first, or maximum chordal dimension 436. Portion 434 also at least partially defines a longitudinally inner portion 438 of blade 412 that extends from maximum chordal dimension 436 to root portion 420. Moreover, portion 434 at least partially defines a longitudinally outer portion 440 on blade 412 that extends from maximum chordal dimension 436 to tip portion 122 (shown in FIG. 1).

Blade 412 further includes a first spar cap 450 extending through at least a portion of each of portions 438 and 440 on suction side surface 433. Moreover, blade 412 includes a second spar cap (not shown) on the pressure side surface that is substantially similar to spar cap 450. In the exemplary embodiment, spar cap 450 is positioned in the vicinity of a thickest portion (not shown) of skin 430. Alternatively, spar cap 450 is positioned anywhere on blade 412 that facilitates operation of blade 412 as described herein. Spar cap 450 defines a second chordal dimension 454 that is less than first, or maximum chordal dimension 436. Spar cap 550 also includes a first end 455 that is positioned in portion 438. Specifically, in this alternative embodiment, first end 455 is positioned within portion 420. Furthermore, spar cap 450 includes a second end (not shown) that is positioned in portion 440. Alternatively, first end 455 and the second end are positioned anywhere on blade 412 that facilitates operation of blade 412 as described herein. Spar cap 450 is oriented substantially longitudinally and extends generally linearly from first end 455 to the second end.

Blade 412 also includes a root end extended section 456 that extends at least partially longitudinally inward from chord 436. In this alternative embodiment, section 456 includes a plurality of overlapping plies 458, wherein at least a portion of plies 458 overlap spar cap 450 and at least a portion of each other. Specifically, in this alternative embodiment, there are four overlapping plies 458 with a staggered overlap. More specifically, in this alternative embodiment, section 456 includes a first overlapping ply 460, a second overlapping ply 466, a third overlapping ply 472, and a fourth overlapping ply 478.

In the alternative embodiment, skin 430, spar cap 450 and root end extended section 456 are at least partially formed of a fiber-resin matrix (not shown) that includes a plurality of plies (not shown) using known methods. Specifically, in this alternative embodiment, the fiber resin matrix is formed via known infusion methods wherein a plurality of layers of a reinforcing material (not shown) is positioned within a mold (not shown) and the reinforcing material is saturated with a resin (not shown) and heat-cured, wherein each of the layers form each of the plies (not shown) within the fiber-resin matrix. Further, in the alternative embodiment, the reinforcing material is a plurality of layers of continuous fiberglass filaments (not shown) and the resin is a thermosetting epoxy resin (not shown). Alternatively, any materials that facilitate forming blade 412 as described herein are used.

Also, alternatively, known hand lay-up fabrication methods to form a fiber-resin matrix are used. Specifically, a layer of predetermined reinforcing material (not shown) is placed into a mold structure (not shown) and a predetermined resin (not shown) is subsequently added into the mold to saturate the reinforcing material, thereby at least partially forming a first layer (not shown) of the fiber-resin matrix. Additional layers (not shown) may be added in a manner similar to that described above. Subsequently, the saturated layers are cured within the mold, wherein each of the layers form each of the plies (not shown) within the fiber-resin matrix. Further, in this alternative embodiment, the reinforcing material is a plurality of layers of continuous fiberglass filaments (not shown) and the resin is a thermosetting epoxy resin (not shown). Alternatively, any materials that facilitate forming blades 412 as described herein are used.

In the alternative embodiment, the fiber resin matrix for spar cap section 450 is formed by assembly methods that include using a plurality of first fiber filaments 463, wherein fiber filaments 463 are substantially continuous and have predetermined orientations within spar cap 450 based on desired load-carrying characteristics of blade 412. In the exemplary embodiment, such orientation is substantially unidirectional. Alternatively, fiber filaments 463 have any orientation that facilitates operation of blade 412 as described herein. Also, alternatively, fiber filaments 463 are formed into strands (not shown) using known assembly methods. Further, alternatively, the strands are formed into rovings (not shown) using known assembly methods. Moreover, alternatively, a combination of the three filament assembly methods are used together in a predetermined combination that is at least partially based on predetermined load transfers characteristics of blade 412.

Further, in this alternative embodiment, each of overlapping plies 458 is similarly formed with a predetermined number of fiber filaments (and/or strands and/or rovings, neither shown) with predetermined lengths and densities that are based on predetermined load-carrying characteristics of blade 412. Moreover, such orientation of each ply 458 to the other plies 458 and spar cap 450 defines a plurality of chordal dimensions. Specifically, in increasing order, a third, fourth, fifth, and sixth chordal dimension 484, 486, 488, and 490, respectively, facilitates simulating a flaring effect. Also, each of plies 458 has any longitudinal dimension and any chordal dimension with any overlapping configuration with any one of plies 458 and spar cap 450 that facilitates operation of blade 412 as described herein. Furthermore, a longitudinal innermost portion of each of plies 458 may be fanned and flared in a manner similar to that described above for section 256 of blade 212 (both shown in FIGS. 4 and 5).

Spar cap 450 and plies 458 facilitate load transfer and load management within blade 412 by facilitating even distribution of load paths such that the associated loads are symmetrically loaded and dispersed at root portion 420 or, alternatively, such loads are distributed with a desired load configuration. Such load distribution facilitates mitigating fatigue and distortion of blade 412 at root portion 420, thereby facilitating mitigation of operational repair costs and capital replacement costs.

The methods for forming wind turbine blades as described herein facilitates operation of a wind turbine system. Specifically, the method of forming the wind turbine blade as described above with the spar cap extensions and/or the modified spar cap facilitates load transfer and load management within the blade. Such load transfer and management facilitates even distribution of load paths such that the associated loads are symmetrically loaded and dispersed at a root portion or, alternatively, such loads are distributed with a desired load configuration. Such load distribution facilitates mitigating fatigue and distortion of the blade at the root portion, thereby facilitating mitigation of operational repair costs and capital replacement costs.

Exemplary embodiments of wind turbine blades as associated with wind turbine systems are described above in detail. The methods, apparatus and systems are not limited to the specific embodiments described herein nor to the specific illustrated wind turbine blades.

While the invention has been described in terms of various specific embodiments, those skilled in the art will recognize that the invention can be practiced with modification within the spirit and scope of the claims.

What is claimed is:

1. A method of forming a wind turbine blade, said method comprising:
forming a root portion, a tip portion, and an airfoil portion extending radially outward from the root portion to the tip portion;
forming a spar cap extending radially outward from the root portion through at least a portion of the airfoil portion, wherein at least a portion of the spar cap is oriented substantially longitudinally and extends generally linearly from a first end of the spar cap to a second end of the spar cap; and
forming at least one spar cap extension extending from the spar cap, wherein at least a portion of the spar cap extension is oriented nonlinearly relative to the spar cap.

2. A method in accordance with claim 1 wherein forming at least one spar cap extension comprises extending the at least one spar cap extension from the spar cap at a predetermined angle.

3. A method in accordance with claim 2 wherein extending the at least one spar cap extension from the spar cap at a predetermined angle comprises extending the at least one spar cap extension from the spar cap at an angle within a range of approximately 0° to 40°.

4. A method in accordance with claim 1 wherein forming at least one spar cap extension that extends from the spar cap comprises at least one of:
forming a first plurality of fiber filaments, wherein a first portion of the first plurality of fiber filaments is substantially co-linear with the spar cap and a second portion of the first plurality of fiber filaments diverges obliquely from the first portion of the first plurality of fiber filaments; and
forming a second plurality of fiber filaments that diverge obliquely from the first plurality of fiber elements.

5. A method in accordance with claim 1 wherein forming at least one spar cap extension comprises forming a plurality of laminated layers, the plurality of laminated layers including at least one first laminated layer and at least one second laminated layer, wherein the at least one first laminated layer and the at least one second laminated layer at least partially overlap.

6. A method in accordance with claim 5 wherein forming the plurality of laminated layers comprises radially staggering the first and second laminated layers.

7. A method in accordance with claim 1 further comprising at least one of:
assembing at least a portion of a plurality of fiber filaments into a plurality of strands; and
assembling at least a portion of the plurality of strands into a plurality of rovings.

8. A method in accordance with claim 7 further comprising forming at least one of the plurality of fiber filaments, the plurality of strands, and the plurality of rovings to have at least one of:
a substantially continuous longitudinal length; and
a substantially unidirectional orientation.

9. A method in accordance with claim 1 wherein forming a root portion comprises forming at least one laminated layer that defines a variable chordal dimension that increases as a function of distance from the airfoil portion.

10. A wind turbine blade comprising:
a root portion, a tip portion, and an airfoil portion extending radially outward from said root portion to said tip portion;
a spar cap extending radially outward from said root portion through at least a portion of said airfoil portion, wherein at least a portion of said spar cap is oriented substantially longitudinally and extends generally linearly from a first end of said spar cap to a second end of said spar cap; and
at least one spar cap extension extending from said spar cap, wherein at least a portion of said spar cap extension is oriented nonlinearly relative to said spar cap.

11. A wind turbine blade in accordance with claim 10 wherein said at least one spar cap extension extends from said spar cap at a predetermined angle.

12. A wind turbine blade in accordance with claim 11 wherein said at least one spar cap extension extends from said spar cap at an angle within a range of approximately 0° to 40°.

13. A wind turbine blade in accordance with claim 10 wherein said at least one spar cap extension that extends from said spar cap comprises at least one of:
a first plurality of fiber filaments, wherein a first portion of said first plurality of fiber filaments is substantially co-linear with said spar cap and a second portion of said first plurality of fiber filaments diverges obliquely from said first portion of said first plurality of fiber filaments; and
a second plurality of fiber filaments that diverge obliquely from said first plurality of fiber elements.

14. A wind turbine blade in accordance with claim 10 wherein said at least one spar cap extension comprises a plurality of laminated layers comprising at least one first laminated layer and at least one second laminated layer, wherein said at least one first laminated layer and at least one second laminated layer at least partially overlap.

15. A wind turbine blade in accordance with claim 14 wherein said first and second laminated layers are radially staggered.

16. A wind turbine blade in accordance with claim 10 further comprising at least one of:
a portion of a plurality of fiber filaments formed into a plurality of strands; and
at least a portion of said plurality of strands formed into a plurality of rovings.

17. A wind turbine blade in accordance with claim 16 wherein at least one of said plurality of fiber filaments, said plurality of strands, and said plurality of rovings have at least one of:
a substantially continuous longitudinal length; and
a substantially unidirectional orientation.

18. A wind turbine blade in accordance with claim 10 wherein said root portion comprises at least one laminated layer that defines a variable chordal dimension that increases as a function of distance from said airfoil portion.

19. A wind turbine system comprising:
a rotatable member rotatably coupled to a load; and
at least one wind turbine blade coupled to said rotatable member, wherein said blade comprises:
a root portion, a tip portion, and an airfoil portion extending radially outward from said root portion to said tip portion;
a spar cap extending radially outward from said root portion through at least a portion of said airfoil portion, wherein at least a portion of said spar cap is oriented substantially longitudinally and extends generally linearly from a first end of said spar cap to a second end of said spar cap; and
at least one spar cap extension extending from said spar cap, wherein at least a portion of said spar cap extension is oriented nonlinearly relative to said spar cap.

20. A wind turbine system in accordance with claim 19 wherein said root portion comprises at least one laminated layer that defines a variable chordal dimension that increases as a function of distance from said airfoil portion.
